(19) United States
(12) Patent Application Publication
(10) Pub. No.: US 2018/0216548 A1
(43) Pub. Date: Aug. 2, 2018

(54) SYSTEM AND METHOD FOR DETERMINING SUPERCHARGER DRIVE RATIO IN A VEHICLE PROPULSION SYSTEM

(71) Applicant: GM GLOBAL TECHNOLOGY OPERATIONS LLC, Detroit, MI (US)

(72) Inventors: Mark R Claywell, Birmingham, MI (US); Maqsood Rizwan Ali Khan, Rochester Hills, MI (US)

(21) Appl. No.: 15/421,680

(22) Filed: Feb. 1, 2017

(51) Int. Cl. F02D 41/00; F02D 41/26; F02D 9/08; F02B 37/12

(52) U.S. Cl. CPC F02D 41/0007; F02D 41/26; F02D 9/08; F02D 2200/0406; F02D 2200/101; F02D 2200/0404; F02B 37/127

(57) ABSTRACT

A method and system for determining a drive ratio of a supercharger in a vehicle propulsion system includes sensing an engine speed of an engine in the propulsion system, providing an engine speed signal based upon the sensed engine speed, sensing an inlet air pressure of the supercharger, providing a supercharger inlet air pressure signal based upon the sensed supercharger inlet air pressure over a dedicated communication channel to a processor in the vehicle, and determining, in the processor, a drive ratio for the supercharger based upon the engine speed signal, the supercharger inlet air pressure signal, and a lobe count of the supercharger.

### FIELD

The present disclosure relates to a system and method for determining supercharger drive ratio in a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

A supercharger may be used to increase the performance of an engine in a propulsion system by increasing the pressure and density of the air being provided to an internal combustion engine. The increase in air provides more oxygen which enables increased and/or more efficient combustion of fuel. This leads to the engine performing more work and increasing power. Typically, a supercharger is driven mechanically using a belt, chain, gears, or other means connecting the supercharger to the crankshaft of the engine. The ratio between the rate at which the crankshaft of an engine rotates and the rate at which the supercharger drive shaft rotates is known as the drive ratio and is determined by the coupling between the supercharger input drive shaft and the crankshaft. There are also some systems which may controllably vary the drive ratio. If that drive ratio is unintentionally modified by, for example, a belt slipping or other alteration of the coupling, then this may result in unintended damage to the supercharger and/or to the engine.

### SUMMARY

In an exemplary aspect, a method for determining a drive ratio of a supercharger in a vehicle propulsion system includes sensing an engine speed of an engine in the propulsion system, providing an engine speed signal based upon the sensed engine speed, sensing an inlet air pressure of the supercharger, providing a supercharger inlet air pressure signal based upon the sensed supercharger inlet air pressure over a dedicated communication channel to a processor in the vehicle, and determining, in the processor, a drive ratio for the supercharger based upon the engine speed signal, the supercharger inlet air pressure signal, and a lobe count of the supercharger.

In another exemplary aspect, the method includes comparing the determined drive ratio to a predetermined drive ratio, and providing a response if the comparison determines that the determined drive ratio is different from the predetermined drive ratio.

In another exemplary aspect, the response includes one of activating an indicator in the vehicle and revising a control of the propulsion system.

In another exemplary aspect, the method includes comparing the drive ratios across multiple engine speeds and providing a response if the drive ratios vary as the engine speeds vary.

In another exemplary aspect, sensing the engine speed includes sensing a crankshaft angle, and providing an engine speed signal includes providing a crankshaft angle signal.

In another exemplary aspect, the method includes comparing the relative amplitudes of pressure pulses in the supercharger inlet air pressure signal, and providing a response if the comparison reveals a variation in the relative amplitudes.

In another exemplary aspect, the method includes substantially closing a supercharger bypass.

In another exemplary aspect, the method includes determining whether a supercharger bypass is substantially closed and determining of the drive ratio based upon the supercharger inlet air pressure signal while the supercharger bypass is substantially closed.

In another exemplary aspect, a vehicle propulsion system includes a supercharger having an inlet and an outlet, an engine having an inlet in communication with the outlet of the supercharger, an engine speed sensor that outputs an engine speed signal, a pressure sensor in communication with the inlet of the supercharger and that outputs a supercharger inlet air pressure signal, and a processor having a communication channel dedicated to the pressure sensor and programmed to determine a drive ratio of the supercharger based upon the engine speed signal, the supercharger inlet air pressure signal received via the dedicated communication channel, and a lobe count for the supercharger.

In another exemplary aspect, the processor is further programmed to compare the determined drive ratio to a predetermined drive ratio, and provide a response if the comparison determines that the determined drive ratio is different from the predetermined drive ratio.

In another exemplary aspect, the response includes one of activating an indicator in the vehicle and revising a control of the propulsion system.

In another exemplary aspect, the processor is further programmed to compare the drive ratios across multiple engine speeds and provide a response if the drive ratios vary as the engine speeds vary.

In another exemplary aspect, the engine speed sensor includes an engine crankshaft angle sensor that provides a crankshaft angle signal.

In another exemplary aspect, the processor is further programmed to compare the relative amplitudes of pressure pulses in the supercharger inlet air pressure signal, and provide a response if the comparison reveals a variation in the relative amplitudes.

In another exemplary aspect, the system further includes a supercharger bypass including a bypass throttle and a bypass throttle position sensor the outputs a bypass throttle position signal and the controller is in communication with the bypass throttle position sensor to receive the bypass throttle position signal and determines the drive ratio based upon the supercharger inlet air pressure signal when the bypass throttle position signal indicates that the bypass throttle is substantially closed.

In this manner, a change of supercharger drive ratio is detectable and control over the drive ratio and/or over the propulsion system may be adjusted in response to the detected change of drive ratio.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic representation of an exemplary propulsion system air intake including a supercharger and an engine;

FIG. 2 illustrates a signal trace from a supercharger inlet pressure sensor; and

FIG. 3 is a flowchart of an exemplary method for determining a supercharger drive ratio in accordance with an exemplary embodiment of the present disclosure.

### DETAILED DESCRIPTION

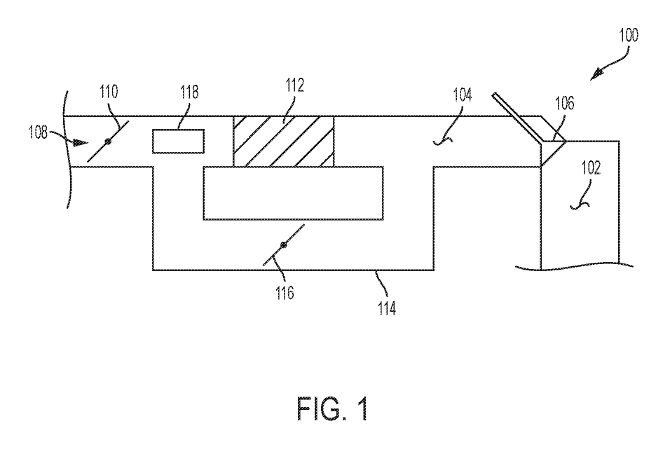

FIG. 1 is a schematic representation of an exemplary supercharger and engine system 100. The system includes a cylinder bore 102 in an engine block. It is understood that while FIG. 1 only illustrates a single cylinder bore 102, an engine may have multiple cylinder bores and benefit from the present invention. The system 100 includes an intake manifold 104 which selectively communicates with the cylinder bore 102 through an intake valve 106 positioned in a port of the cylinder. The system 100 further includes an air intake 108. Flow of air through the intake is moderated with an intake throttle 110. The flow of air continues past the intake throttle 110 and is compressed by a supercharger 112. The air compressed by the supercharger 112 is provided to the intake manifold 104 for supply to the cylinder 102 by the intake valve 106. The system 100 also includes a bypass path 114 which communicates at one end with the intake manifold 104 and the supercharger air inlet 108 at the other end. Flow through the bypass path 114 is modulated by a bypass valve 116.

An electronic control unit (ECU, not shown) may be connected to control the intake throttle 110 and the bypass valve 116 as well as many other things as is well understood in the art. The ECU may be programmed to input and use other signals and information including a signal from an inlet pressure sensor 118 which is positioned upstream of the supercharger. Conventionally, an ECU samples the inlet pressure signal only infrequently in accordance with the clock speed of the ECU or at some other known system sampling rate. However, these previous systems have a slow sampling rate which does not provide the ability to determine a drive ratio for the supercharger. Rather, the slow sampling rate only provides a representative average of the inlet pressure over a relatively long period of time.

In stark contrast, an exemplary embodiment of the present disclosure samples the inlet pressure signal at a rate which is sufficient to observe individual pulses in the pressure which are due to the operation of the supercharger. Using this sampling rate it becomes possible to determine operational speed of the supercharger and, along with the crankshaft speed of the engine, determine the drive ratio of the supercharger. In an exemplary embodiment, the inlet pressure signal may be provided with its own dedicated channel so that the signal is reliably sampled at a frequency that is sufficient to resolve pulses due to the supercharger within the supercharger air inlet.

In order to determine what sampling rate might be sufficient, the inventors provide the following equation:

F>=(DRmax)*L*(Wmax)*Q*N

Where: F is the minimum sampling rate, DRmax is the maximum drive ratio, L is the number of lobes in the supercharger, Wmax is the maximum engine speed, Q is a multiplier to capture two times the primary order of signal frequency, and N is a multiplier which is chosen that the sampling rate is high enough to capture at least two times the bandwidth of the frequency.

After determining the minimum sampling rate, the structure of the system which is required to support such a sampling rate may be determined. In some systems, the standard software cycle rate might be five milliseconds, for example, which would result in a sampling rate of 200 hertz. If this sampling rate is not sufficient, then the system may require a communication channel capable of a higher sampling rate. An example of a known communication channel that should have a sufficiently high sampling rate is generally known as a “dedicated” channel.

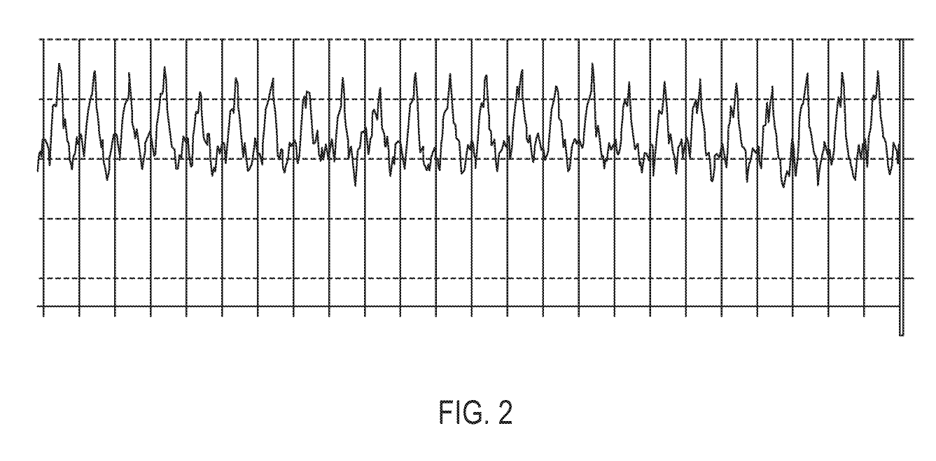

To illustrate this point, FIG. 2 illustrates a trace of an inlet pressure signal from an inlet pressure sensor having a dedicated channel. The horizontal axis of the graph represents the engine crank angle and the vertical axis represents the amplitude of the inlet pressure signal. With the fast sampling rate, a clear repeatable pattern emerges. That repeated pattern indicates the pressure pulses reflecting off of the lobes of the supercharger as it rotates and collects volumes of air for compression. Therefore, the pressure signal provides a direct indication of the operating speed of the supercharger. By comparing the operational speed of the supercharger with the rotational speed of the crankshaft, the drive ratio may be determined. The drive ratio may be generally determined using the following equation:

DR=F/(L * W)

Where DR is the drive ratio, F is the frequency of pressure pulses in the inlet, L is the lobe count for the supercharger, and W is the engine speed (or crankshaft speed). Analysis of the inlet pressure signal in FIG. 2 reveals the frequency of the pressure pulses in the inlet F. Knowing the engine speed, W, from the crankshaft speed sensor and the lobe count of one rotor of the supercharger, which is a constant, the drive ratio at any given moment may be directly calculated.

In this manner, potential issues with the supercharger system relating to the drive ratio, such as, for example, belt slippage or the like, it can now be detected in real time during operation of the vehicle propulsion system and various measures may be implemented in response. For example, the control system for the vehicle may alter the manner in which it controls the propulsion system to avoid problems and/or damage, an indicator to the operator may be provided, or the like without limitation. In exemplary embodiments, the engine controller may switch to a different engine control program or map, open the bypass permanently, adjust the bypass opening, go into a “safe mode”, adjusting the fuel being provided to the engine, adjust the spark, store a flag in memory indicating the change, communicate the change, apply a torque model offset, offset the drive ratio controls in a variable drive ratio system, or the like without limitation.

Further, in an exemplary embodiment, the method and system may analyze the relative amplitudes of the inlet pressure signal and determine the efficiency of each lobe or rotor of the supercharger. For example, a reduction or other alteration in the pulse amplitudes may indicate damage and/or wear in the supercharger. Various measures may be taken in response to that detection such as, for example, limiting the boost by controlling the bypass or the like, without limitation.

If a belt driving the pulleys in the supercharger drive system wears, stretches, or starts to fail, these conditions may be detected prior to complete failure and measures may be taken in response. The exemplary embodiment is capable of determining when a drive ratio may change with changing load or engine speed which may be indicative of drive belt slippage.

In an exemplary method and system, the bypass may be closed or reduced to avoid or minimize potential noise being propagated upstream through the bypass system. Pressure dynamics in the intake manifold pressure may be caused by elements other than the supercharger in the powertrain such as, for example, pressure signals from the intake ports, valve train, induction noise or the like. When the bypass 114 is completely open, these pressure signals may propagate into the intake of the supercharger and become a source of noise in the inlet pressure signal. An exemplary method and system of the present disclosure may control the flow through the bypass to minimize the noise in the inlet such as by, for example, controlling the bypass throttle 116 to move to a closed or substantially closed position.

While the exemplary embodiments described above have been in relation to a supercharger drive system having a generally constant drive ratio, the present methods and systems may also be used in a supercharger drive system having a variable ratio. Deviations from the desired drive ratio may be detected using the present disclosure and the variable ratio drive system may be controlled based upon the feedback provided by the present disclosure. An exemplary embodiment provides a method and system for diagnosing the actual drive ratio in a variable ratio system and, as such, provides the capability to diagnose and detect potential or actual failures in such a variable drive ratio system in addition to a constant drive ratio system.

While the exemplary embodiment illustrated in FIG. 1 shows an inlet pressure sensor 118 in the inlet channel after the intake throttle, 110, the inlet pressure sensor 118 may be positioned anywhere within the inlet channel before the supercharger without limitation and still form a part of the present disclosure.

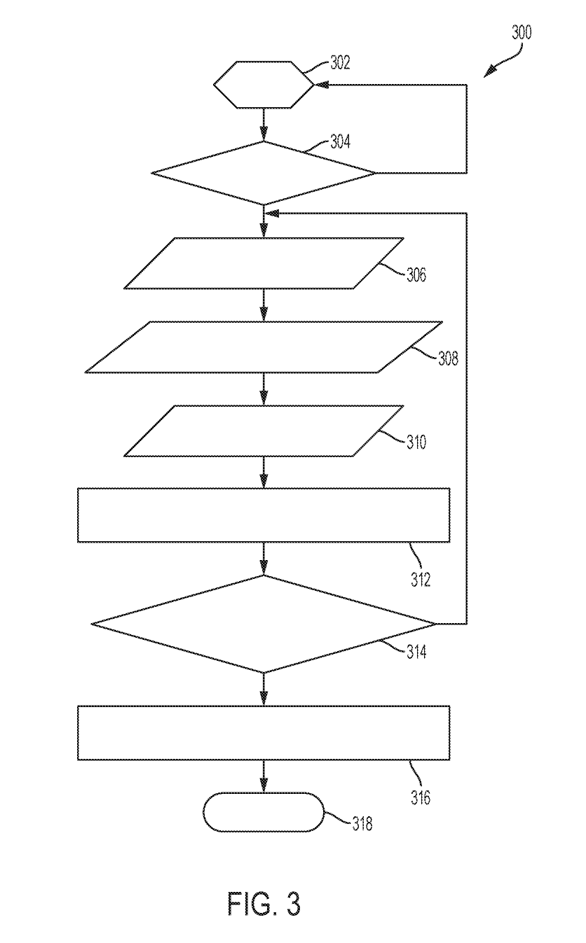

FIG. 3 is a flowchart of an exemplary method 300 for determining a supercharger drive ratio in accordance with an exemplary embodiment of the present disclosure. The method starts at step 302 and continues to step 302 where the method determines whether the bypass is greater than 80% closed. If, in step 302, the method determines that the bypass is not greater than 80% closed, then the method returns to step 302. If, however, the method determines that the bypass is more than 80% closed the method continues to step 306.

In step 306, the method measures and stores the supercharger inlet air pressure at multiple engine speeds and continues to step 308. In step 308, the method records the engine speeds simultaneously with the supercharger inlet air pressures measured in step 306 and continues to step 310. In step 310, the method computes the supercharger speed based on the stored supercharger inlet air pressures and continues to step 312. In step 312, the method determines the supercharger drive ratio across multiple engine speed points and continues to step 314. In step 314, the method determines whether the determined supercharger drive ratio has changed. If, in step 314, the method determines that the supercharger drive ratio has not changed, then the method returns to step 306. If, however, in step 314, the method determines that the supercharger drive ratio has changed, then the method stores that new drive ratio and provides a response. The method then continues to step 318 where the method ends.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for determining a drive ratio of a supercharger in a vehicle propulsion system, the method comprising:
sensing an engine speed of an engine in the propulsion system;
providing an engine speed signal based upon the sensed engine speed;
sensing an inlet air pressure of the supercharger;
providing a supercharger inlet air pressure signal based upon the sensed supercharger inlet air pressure over a dedicated communication channel to a processor in the vehicle; and
determining, in the processor, a drive ratio for the supercharger based upon the engine speed signal, the supercharger inlet air pressure signal, and a lobe count of the supercharger.

2. The method of claim 1, further comprising:
comparing the determined drive ratio to a predetermined drive ratio; and
providing a response if the comparison determines that the determined drive ratio is different from the predetermined drive ratio.

3. The method of claim 2, wherein the response comprises one of activating an indicator in the vehicle and revising a control of the propulsion system.

4. The method of claim 1, further comprising comparing the drive ratios across multiple engine speeds and providing a response if the drive ratios vary as the engine speeds vary.

5. The method of claim 1, wherein sensing the engine speed comprises sensing a crankshaft angle, and wherein providing an engine speed signal comprises providing a crankshaft angle signal.

6. The method of claim 1, further comprising:
comparing the relative amplitudes of pressure pulses in the supercharger inlet air pressure signal; and
providing a response if the comparison reveals a variation in the relative amplitudes.

7. The method of claim 1, further comprising substantially closing a supercharger bypass.

8. The method of claim 7, further comprising determining whether a supercharger bypass is substantially closed and wherein the determining of the drive ratio is based upon the supercharger inlet air pressure signal while the supercharger bypass is substantially closed.

9. A method for determining a drive ratio of a supercharger in a vehicle propulsion system, the method comprising:
sensing an engine speed of an engine in the propulsion system;
providing an engine speed signal based upon the sensed engine speed;
sensing an inlet air pressure of the supercharger;
providing a supercharger inlet air pressure signal based upon the sensed supercharger inlet air pressure over a dedicated communication channel to a processor in the vehicle;
determining a frequency of pressure pulses in the supercharger inlet air pressure signal;
comparing the frequency of pressure pulses to an expected frequency of pressure pulses; and
providing a response if the comparison determines that the determined frequency is different from the expected frequency.

10. A vehicle propulsion system, the system comprising:
a supercharger having an inlet and an outlet;
an engine having an inlet in communication with the outlet of the supercharger;
an engine speed sensor that outputs an engine speed signal;
a pressure sensor in communication with the inlet of the supercharger and that outputs a supercharger inlet air pressure signal; and
a processor having a communication channel dedicated to the pressure sensor and programmed to determine a drive ratio of the supercharger based upon the engine speed signal, the supercharger inlet air pressure signal received via the dedicated communication channel, and a lobe count for the supercharger.

11. The system of claim 10, wherein the processor is further programmed to:
compare the determined drive ratio to a predetermined drive ratio; and
provide a response if the comparison determines that the determined drive ratio is different from the predetermined drive ratio.

12. The system of claim 11, wherein the response comprises one of activating an indicator in the vehicle and revising a control of the propulsion system.

13. The system of claim 10, wherein the processor is further programmed to compare the drive ratios across multiple engine speeds and provide a response if the drive ratios vary as the engine speeds vary.

14. The system of claim 10, wherein the engine speed sensor comprises an engine crankshaft angle sensor that provides a crankshaft angle signal.

15. The system of claim 10, wherein the processor is further programmed to:
compare the relative amplitudes of pressure pulses in the supercharger inlet air pressure signal; and
provide a response if the comparison reveals a variation in the relative amplitudes.

16. The system of claim 10, further comprising a supercharger bypass including a bypass throttle and a bypass throttle position sensor the outputs a bypass throttle position signal and wherein the controller is in communication with the bypass throttle position sensor to receive the bypass throttle position signal and determines the drive ratio based upon the supercharger inlet air pressure signal when the bypass throttle position signal indicates that the bypass throttle is substantially closed.
